(19) United States
(12) Patent Application Publication
(10) Pub. No.: US 2022/0264327 A1
(43) Pub. Date: Aug. 18, 2022

(54) COMMUNICATION DEVICE AND NON-TRANSITORY COMPUTER READABLE STORAGE MEDIUM

(71) Applicant: KABUSHIKI KAISHA TOKAI RIKA DENKI SEISAKUSHO, Aichi (JP)

(72) Inventors: Masateru FURUTA, Aichi (JP); Tadashi FUKAGAI, Aichi (JP); Yuki KONO, Aichi (JP); Yutaka KUBO, Aichi (JP)

(73) Assignee: KABUSHIKI KAISHA TOKAI RIKA DENKI SEISAKUSHO, Aichi (JP)

(21) Appl. No.: 17/588,724

(22) Filed: Jan. 31, 2022

(30) Foreign Application Priority Data
Feb. 16, 2021 (JP) 2021-022345

(51) Int. Cl. H04W 24/02; H04W 4/02

(52) U.S. Cl. CPC H04W 24/02; H04W 4/023

(57) ABSTRACT

A communication device comprising: a wireless communication section capable of wirelessly transmitting and receiving a signal to and from another communication device; and a control section configured to control the wireless communication section in such a manner that the wireless communication section performs a first process and a second process, the first process including transmitting the signal while switching a frequency to be used among a plurality of frequencies, the second process including performing communication by using an optimum frequency that is a frequency selected from among the plurality of frequencies in the first process.

### CROSS REFERENCE TO RELATED APPLICATION(S)

This application is based upon and claims benefit of priority from Japanese Patent Application No. 2021-022345, filed on Feb. 16, 2021, the entire contents of which are incorporated herein by reference.

### BACKGROUND

The present invention relates to a communication device and a non-transitory computer readable storage medium.

In recent years, technologies of performing various kinds of processes in accordance with a result of transmitting/receiving a wireless signal between devices have been developed. For example, JP 2020-118030A discloses a technology of measuring a distance between devices by using ultra-wideband (UWB) signals.

In a system using wireless signals as described above, it is common to transmit and receive signals using a designated frequency. However, even if the same frequency is used fixedly and continuously, sometimes the communication situation may not be improved.

Accordingly, the present invention is made in view of the aforementioned issue, and an object of the present invention is to provide a mechanism that makes it possible to improve the communication situation related to wireless communication section.

### SUMMARY

To solve the above described problem, according to an aspect of the present invention, there is provided a communication device comprising: a wireless communication section capable of wirelessly transmitting and receiving a signal to and from another communication device; and a control section configured to control the wireless communication section in such a manner that the wireless communication section performs a first process and a second process, the first process including transmitting the signal while switching a frequency to be used among a plurality of frequencies, the second process including performing communication by using an optimum frequency that is a frequency selected from among the plurality of frequencies in the first process.

To solve the above described problem, according to another aspect of the present invention, there is provided a communication device comprising: a wireless communication section capable of wirelessly transmitting and receiving a signal to and from another communication device; and a control section configured to control the wireless communication section in such a manner that the wireless communication section performs a first process and a second process, the first process including receiving the signal while switching a frequency to be used among a plurality of frequencies, the second process including performing communication by using an optimum frequency that is a frequency selected from among the plurality of frequencies in the first process.

To solve the above described problem, according to another aspect of the present invention, there is provided a non-transitory computer readable storage medium having a program stored therein, the program causing a computer to control a wireless communication section in such a manner that the wireless communication section performs a first process and a second process, the computer being configured to control a communication device including the wireless communication section capable of wirelessly transmitting and receiving a signal to and from another communication device, the first process including transmitting the signal while switching a frequency to be used among a plurality of frequencies, the second process including performing communication by using an optimum frequency that is a frequency selected from among the plurality of frequencies in the first process.

As described above, according to the present invention, it is possible to provide the mechanism that makes it possible to improve the communication situation related to wireless communication section.

### BRIEF DESCRIPTION OF THE DRAWINGS

FIG. 1 is a block diagram illustrating an example of configuration of a system according to an embodiment of the present disclosure.

FIG. 2 is a diagram illustrating an example of relationship between frequency and signal directivity.

FIG. 3 is a sequence diagram illustrating an example of a flow of a process performed by the system according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Configuration Example

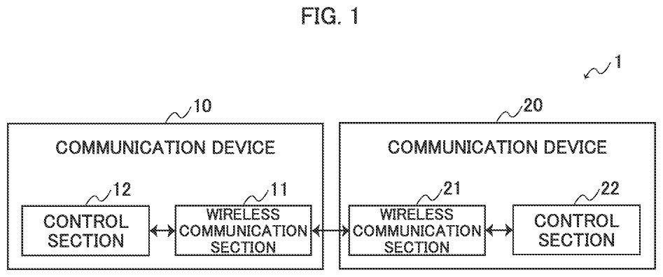

FIG. 1 is a block diagram illustrating an example of configuration of a system 1 according to an embodiment of the present disclosure. As illustrated in FIG. 1, the system 1 includes a communication device 10 and a communication device 20.

For example, the communication device 10 is a portable device 10 configured to be carried by a user. On the other hand, the communication device 20 is an in-vehicle device configured to be installed in a vehicle.

For example, the in-vehicle device may perform wireless communication with the portable device, and may perform various kinds of control on a basis of results of the wireless communication.

As an example, the control includes control over unlocking/locking of doors of a vehicle and control over starting/stopping of an engine.

For example, the in-vehicle device may perform control to unlock the doors and start the engine in a case where a distance between the portable device and the in-vehicle device is estimated to be a designated distance or less on the basis of a result of the wireless communication with the portable device. Alternatively, the in-vehicle device may perform control to lock the doors and stop the engine in a case where the distance between the portable device and the in-vehicle device is estimated to exceed the designated distance on the basis of a result of the wireless communication with the portable device.

(1) Communication Device 10

As illustrated in FIG. 1, the communication unit 10 includes a wireless communication section 11 and a control section 12.

The wireless communication section 11 has a function of performing wireless communication. For example, the wireless communication section 11 is capable of wirelessly transmitting and receiving signals to and from the communication device 20. The wireless communication section 11 performs the wireless communication in conformity with a designated communication standard.

Examples of the designated communication standard according to the present embodiment include ultra-wideband (UWB) wireless communication. The wireless communication section 11 transmits and receives ultra-wideband signals in the case where the ultra-wideband wireless communication is adopted as the designated communication standard.

The wireless communication section 11 is capable of using a plurality of frequencies. The frequency described here may be a frequency channel having a predetermined bandwidth.

For example, the wireless communication section 11 transmits a signal by using one of available frequencies. Here, transmission of a signal using a certain frequency may be transmission of the signal using a carrier wave of the certain frequency.

For another example, the wireless communication section 11 receives a signal by using one of available frequencies. Here, reception of a signal using a certain frequency may be sampling of the signal using a sampling frequency corresponding to the certain frequency.

The wireless communication section 11 is capable of performing wireless communication while switching the frequency to be used among the plurality of available frequencies.

The control section 12 controls overall operation of the control device 10. For example, the control section 12 is implemented by an electronic circuit such as a microprocessor and a central processing unit (CPU). The control section 12 may operate in accordance with various kinds of programs. The control section 12 may include a read only memory (ROM) that stores programs, arithmetic parameters, and the like to be used, and a random access memory (RAM) that temporarily stores parameters and the like that change appropriately.

The control section 12 controls wireless communication performed by the wireless communication section 11. For example, the control section 12 controls switching of frequency to be used by the wireless communication section 11 for the wireless communication. For another example, the control section 12 controls transmission and reception of signals by the wireless communication section 11.

(2) Communication Device 20

As illustrated in FIG. 1, the communication unit 20 includes a wireless communication section 21 and a control section 22.

The wireless communication section 21 has a function of performing wireless communication. For example, the wireless communication section 21 is capable of wirelessly transmitting and receiving signals to and from the communication device 10. The wireless communication section 21 performs the wireless communication in conformity with a designated communication standard.

Examples of the designated communication standard according to the present embodiment include the ultra-wideband (UWB) wireless communication. The wireless communication section 21 transmits and receives ultra-wideband signals in the case where the ultra-wideband wireless communication is adopted as the designated communication standard.

The wireless communication section 21 is capable of using a plurality of frequencies. The frequency described here may be a frequency channel having a predetermined bandwidth.

For example, the wireless communication section 21 transmits a signal by using one of available frequencies. Here, transmission of a signal using a certain frequency may be transmission of the signal using a carrier wave of the certain frequency.

For another example, the wireless communication section 21 receives a signal by using one of the available frequencies. Here, reception of a signal using a certain frequency may be sampling of the signal using a sampling frequency corresponding to the certain frequency.

The wireless communication section 21 is capable of performing wireless communication while switching the frequency to be used among the plurality of available frequencies.

The control section 22 controls overall operation of the control device 20. For example, the control section 22 is implemented by an electronic circuit such as a microprocessor and a central processing unit (CPU). The control section 22 may operate in accordance with various kinds of programs. The control section 22 may include a read only memory (ROM) that stores programs, arithmetic parameters, and the like to be used, and a random access memory (RAM) that temporarily stores parameters and the like that change appropriately.

The control section 22 controls wireless communication performed by the wireless communication section 21. For example, the control section 22 controls switching of frequency to be used by the wireless communication section 21 for the wireless communication. For another example, the control section 22 controls transmission and reception of signals by the wireless communication section 21.

<2. Technical Features>

(1) Directivity

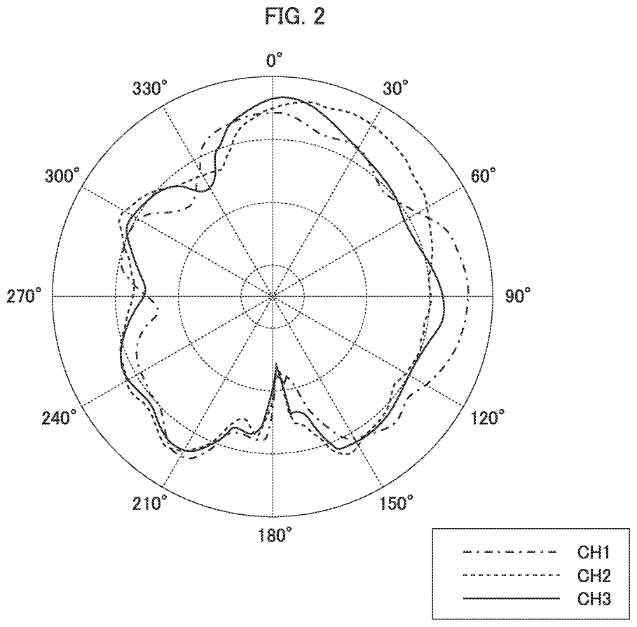

First, relationship between signal directivity and frequency to be used for the wireless communication will be described. FIG. 2 is a diagram illustrating an example of the relationship between frequency and signal directivity. Hereinafter, a device that transmits signals is also referred to as a transmitter, and a device that receives signals is also referred to as a receiver.

FIG. 2 illustrates directivity of respective signals corresponding to frequency channels CH1, CH2, and CH3 in a 360 degree area around a position of an antenna of the transmitter.

As exemplified in FIG. 2, different frequency channels may have different signal directivities even if a same communication standard is used.

For example, in the case of the example illustrated in FIG. 2, a signal corresponding to the frequency channel CH2 propagates to a farthest distance in a direction of 30° from the transmitter. On the other hand, a signal corresponding to the frequency channel CH1 propagates to a farthest distance in a direction of 90° from the transmitter.

Such directivity is strongly affected by noise, multipath, and the like. The multipath means that there are a plurality of propagation paths of a wireless signal between the transmitter and the receiver. For example, in the case of using signals corresponding to a same frequency channel, a same multipath environment is achieved unless an object that intervenes between the transmission and the receiver moves.

Therefore, in the case where the receiver fails to receive a signal transmitted from the transmitter in a certain multipath environment, communication is not established as long as a same frequency channel is used.

In addition, for example, in the case where an environment includes noise corresponding to a frequency channel used for wireless communication but a same frequency channel is continuously used, interference continues unless the noise disappears.

The technical idea of the present invention was conceived by focusing on the above-described points, and is intended to improve possibility of improving the communication situation related to the wireless communication. The communication situation includes a signal-to-noise ratio (SNR), throughput, and the like.

(2) Frequency Selection Process

The communication device 10 and the communication device 20 executes respective frequency selection processes. The frequency selection process is a process of selecting a frequency that makes it possible to improve a communication situation from among a plurality of frequencies available to the communication device 10 and the communication device 20.

In the frequency selection process, the frequency selected from among the plurality of available frequencies may also be referred to as an optimum frequency. After the frequency selection process, the optimum frequency is used for subsequent wireless communication.

Next, details of the frequency selection process will be described.

Signal Transmission and Reception While Switching Frequency

The communication device 10 transmits a signal while switching a frequency to be used among the plurality of available frequencies. For example, the communication device 10 transmits a signal while switching among the frequency channel CH1, the frequency channel CH2, and the frequency channel CH3.

On the other hand, the communication device 20 receives a signal while switching a frequency to be used among the plurality of available frequencies. For example, the communication device 10 receives a signal while switching among the frequency channel CH1, the frequency channel CH2, and the frequency channel CH3. Here, the communication device 20 receives a signal by using a same frequency channel as a frequency channel used by the communication device 10 that has transmitted the signal.

Selection of Optimum Frequency

The communication device 20 selects a frequency of a signal that satisfies a predetermined condition as the optimum frequency from among signals received in the frequency selection process. The signals received in the frequency selection process are the signals received while switching the frequency as described above. Results of receiving the signals reflect respective communication situations related to the plurality of available frequencies. Therefore, such a configuration makes it possible to select a frequency having a best communication situation as the optimum frequency.

The predetermined condition may be a condition that the signal has highest reception strength among the plurality of available frequencies. For example, a received signal strength indicator (RSSI) may be used as the reception strength. Such a configuration makes it possible to select a frequency that is most appropriate for communication as the optimum frequency.

In particular, the predetermined condition may be a condition that a first received signal has highest reception strength among the plurality of available frequencies. The first received signal is a signal that has arrived via a shortest propagation path among a plurality of propagation paths between the transmitter and the receiver. The first received signal is considered to have higher reception strength than subsequent signals to be received. Therefore, the receiver often acquires information from the first received signal. In this respect, such a configuration makes it possible to select a frequency that is most appropriate for acquisition of the information by the receiver, as the optimum frequency.

By switching among the frequencies, it is possible to change the multipath environment and the directivity. Therefore, by switching to the optimum frequency, it is possible to improve possibility of successful communication even at a position where communication is failed by using a frequency before switching to the optimum frequency.

In addition, by switching among the frequencies, it is possible to change the degree of noise interference. Therefore, by switching to the optimum frequency, it is possible to improve possibility of successful communication even in the case where the noise interference has caused communication failure at a frequency before switching to the optimum frequency.

Sharing of Information Indicating Optimum Frequency

The communication device 20 transmits information indicating the selected optimum frequency. Next, the communication device 10 receives the information indicating the optimum frequency selected by the communication device 20. Such a configuration makes it possible to share the optimum frequency between the communication device 10 and the communication device 20.

Next, the communication device 10 and the communication device 20 communicate with each other by using the optimum frequency. Specifically, the communication device 20 performs communication by using the selected optimum frequency. On the other hand, the communication device 10 performs communication by using the optimum frequency indicated by the received information. Such a configuration makes it possible to execute the wireless communication in the improved communication situation in comparison with a communication situation where the frequency is not switched yet through the frequency selection process.

To transmit the information indicating the optimum frequency, the communication device 20 may transmit a signal by using the optimum frequency. In other words, to receive the information indicating the optimum frequency, the communication device 10 may receive the signal transmitted by using the optimum frequency. Such a configuration makes it possible to transmit the information by using the optimum frequency. Therefore, it is possible to notify the communication device 10 of the information indicating the optimum frequency more certainly.

The communication device 10 receives the signal transmitted by using the optimum frequency while switching the frequency to be used among the plurality of available frequencies. Next, the communication device 10 identifies a frequency of a signal that satisfies a predetermined condition as the optimum frequency among respective signals received by using the plurality of available frequencies. Specifically, the communication device 10 performs a process that is similar to the above-described process performed by the communication device 20 for selecting the optimum frequency. Such a configuration allows the communication device 10 to accurately identify the optimum frequency selected by the communication device 20.

Details of the predetermined condition have already been described above. In other words, the predetermined condition may be a condition that a signal has highest reception strength among the plurality of available frequencies. Alternatively, the predetermined condition may be a condition that a first received signal has highest reception strength among the plurality of available frequencies. Such conditions are satisfied in the case where a frequency used by the transmitter is identical to a frequency used by the receiver. This allows the communication device 10 to accurately identify the optimum frequency.

Note that, it is also possible to transmit a signal suitable for other uses such as a ranging signal (to be described later) by using the optimum frequency. In this case, it is possible to reduce a burden of separately transmitting the signal including the information indicating the optimum frequency and the signal suitable for other uses.

(3) Ranging Process

The communication device 10 and the communication device 20 executes respective ranging processes. The ranging process is a process for measuring a distance between the communication device 10 and the communication device 20. Hereinafter, the distance measured through the ranging process is also referred to as a ranging value. When the ranging value is obtained, it becomes possible to perform control over unlocking/locking of doors, control over starting/stopping of an engine, and other control on the basis of the distance between the portable device and the in-vehicle device.

The ranging process includes transmission/reception of a signal and calculation of a ranging value based on propagation delay time of the signal. The propagation delay time is time from transmission to reception of the signal. Hereinafter, the signal transmitted and received for measuring the propagation delay time is also referred to as the ranging signal.

The ranging process may include communication using the optimum frequency selected through the frequency selection process. In this case, the communication device 10 and the communication device 20 transmit/receive the respective ranging signals by using the optimum frequency. The signal transmitted/received using the optimum frequency has a best communication situation among signals transmitted/received using the other frequencies. Therefore, it is considered that a ranging value calculated on the basis of the ranging signal transmitted/received using the optimum frequency is closest to a linear distance between the communication device 10 and the communication device 20 among ranging values calculated on the basis of ranging signals transmitted/received using other frequencies. In other words, such a configuration makes it possible to acquire a more accurate ranging value.

(4) Flow of Process

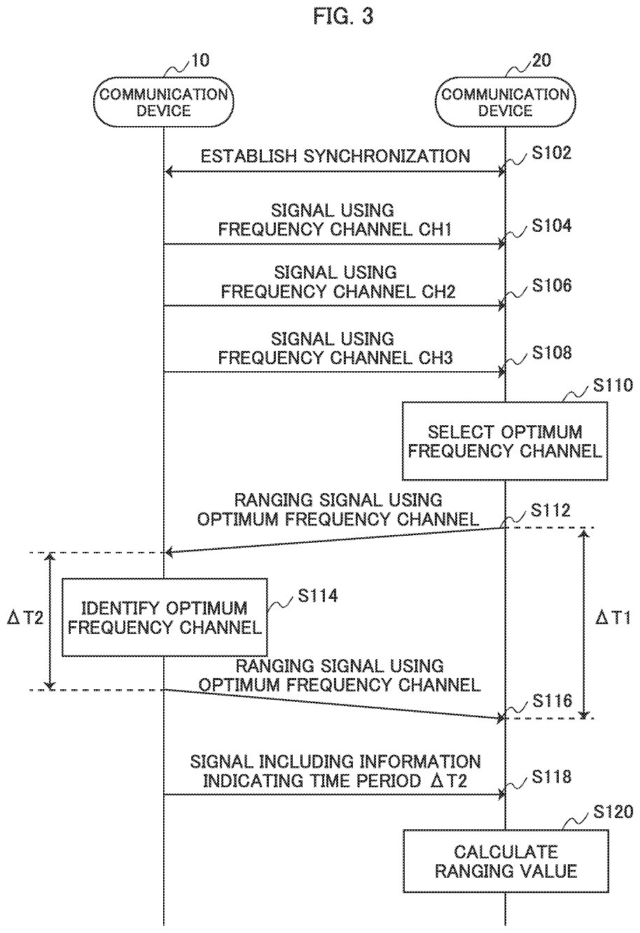

FIG. 3 is a sequence diagram illustrating an example of a flow of a process performed by the system 1 according to the present embodiment. As illustrated in FIG. 3, the communication device 10 and the communication device 20 are involved in this sequence. Here, it is assumed that the frequency channel CH1, the frequency channel CH2, and the frequency channel CH3 are available.

As illustrated in FIG. 3, the communication device 10 and the communication device 20 establish synchronization with each other (Step S102). Here, the synchronization is temporal synchronization. This makes it possible to synchronize timings of transmitting/receiving a signal between the communication device 10 and the communication device 20. For example, a signal in a different frequency band from the UWB may be used for establishing the synchronization. Examples of such a signal include Bluetooth Low Energy (BLE) (registered trademark). For another example, a UWB signal may be used for establishing the synchronization. In this case, it is possible to use the same frequency channel as the frequency channel used for the ranging process. Of course, it is also possible to use a different frequency channel from the frequency channel used for the ranging process.

Next, the wireless communication section 11 of the communication device 10 transmits a signal by using the frequency channel CH1 (Step S104). On the other hand, the wireless communication section 21 of the communication device 20 receives the signal by using the frequency channel CH1.

Next, the wireless communication section 11 of the communication device 10 transmits a signal by using the frequency channel CH2 (Step S106). On the other hand, the wireless communication section 21 of the communication device 20 receives the signal by using the frequency channel CH2.

Next, the wireless communication section 11 of the communication device 10 transmits a signal by using the frequency channel CH3 (Step S108). On the other hand, the wireless communication section 21 of the communication device 20 receives the signal by using the frequency channel CH3.

Next, the control section 22 of the communication device 20 selects an optimum frequency channel from among the frequency channels CH1 to CH3 (Step S110). For example, the control section 22 of the communication device 20 selects a frequency channel that has been used for receiving a signal having a highest reception strength as the optimum frequency channel from among the signals received in Step S104 to Step S108.

Next, the wireless communication section 21 of the communication device 20 transmits a ranging signal by using the optimum frequency channel (Step S112). On the other hand, the wireless communication section 11 of the communication device 10 receives the ranging signal while switching among the frequency channels CH1 to CH3.

Next, the control section 12 of the communication device 10 identifies the optimum frequency channel (Step S114). For example, the control section 12 of the communication device 10 identifies a frequency channel that has been used for receiving a ranging signal having a highest reception strength as the optimum frequency channel among the ranging signals received while switching among the frequency channels CH1 to CH3 in Step S112.

Next, the wireless communication section 11 of the communication device 10 transmits a ranging signal by using the optimum frequency channel (Step S116). On the other hand, the wireless communication section 21 of the communication device 20 receives the ranging signal by using the optimum frequency channel.

Here, the control section 22 of the communication device 20 measures a time period ΔT1 from transmission to reception of the ranging signal. On the other hand, the control section 12 of the communication device 10 measures a time period ΔT2 from reception to transmission of the ranging signal.

Next, the wireless communication section 11 of the control device 10 transmits a signal including information indicating the time period ΔT2 (Step S118). Here, the optimum frequency channel is used for transmitting the signal.

Next, when the signal including the time period ΔT2 is received, the control section 22 of the control device 20 calculates a ranging value on the basis of the measured time period ΔT1 and the received time period ΔT2 (Step S120). Specifically, the control section 22 of the communication device 20 divides a result obtained by calculating (ΔT1-ΔT2) by 2 to calculate one-way propagation delay time of the ranging signal. Next, the control section 22 of the communication device 20 calculates the ranging value by multiplying the propagation delay time by the speed of the ranging signal.

<3. Supplement>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, in the above embodiment, reception strength of a signal and reception strength of a first received signal have been exemplified as the predetermined condition for selecting the optimum frequency through the frequency selection process. However, the present invention is not limited thereto. The predetermined condition may be a condition that a distance measured between the communication device 10 and the communication device 20 on a basis of a received signal is shortest among the plurality of available frequencies. Specifically, in the frequency selection process, the communication device 10 and the communication device 20 perform the ranging process while switching a frequency to be used among the plurality of available frequencies. Next, a frequency from which a shortest ranging value is obtained is selected as the optimum frequency from among respective ranging values obtained by using the plurality of available frequencies. Such a configuration makes it possible to select a frequency at which a distance of a propagation path of a signal indicated by a ranging value is closest to the linear distance between the communication device 10 and the communication device 20, as the optimum frequency.

For example, in the above embodiment, the communication device 10 transmits a signal while switching among the frequencies, and the communication device 20 receives the signal while switching among the frequencies and selects the optimum frequency in the frequency selection process. However, the present invention is not limited thereto. For example, the communication device 20 may transmit a signal while switching among the frequencies, and the communication device 10 may receive the signal while switching among the frequencies and may select the optimum frequency.

For example, in the above embodiment, the frequency selection process has been exemplified as a first process that is a process of transmitting/receiving a signal while switching among frequencies and selecting the optimum frequency. In addition, the ranging process has been exemplified as a second process that is a process including wireless communication using the optimum frequency. However, the present invention is not limited thereto. For example, a process other than the ranging process may be executed as the second process. Examples of such a process include data transmission/reception.

For example, in the above embodiment, the communication device 10 serves as the portable device, and the communication device 20 serves as the in-vehicle device. However, the present invention is not limited thereto. For example, the communication device 10 may serve as the in-vehicle device, and the communication device 20 may serve as the portable device.

For example, in the above embodiment, the wireless communication between the communication device 10 and the communication device 20 relates to control over vehicle. However, the present invention is not limited thereto. The communication device 10 and the communication device 20 may be any devices selected from a device group including portable devices, mobile objects such as vehicles, smartphones, drones, houses, home appliances, and the like.

For example, in the above embodiment, the ultra-wideband wireless communication has been exemplified as the designated communication standard. However, the present invention is not limited thereto. The designated communication standard may be the Bluetooth Low Energy (BLE) (registered trademark) or a communication standard using signals in a low frequency (LF) band and an ultra high frequency (UHF) band.

For example, in the above embodiment, the wireless communication section 11 and the control section 12 are installed in a single device. However, the present invention is not limited thereto. For example, the wireless communication section 11 and the control section 12 may be installed in different devices. The same applies to the wireless communication section 21 and the control section 22.

Note that, the series of processes performed by the devices described in this specification may be achieved by any of software, hardware, and a combination of software and hardware. A program that configures the software is stored in advance in, for example, a recording medium (non-transitory medium) installed inside or outside the devices. In addition, for example, when a computer for controlling the respective devices described in the present specification executes each of the programs, the program is loaded into RAM, and executed by a processor such as a CPU. The storage medium may be a magnetic disk, an optical disc, a magneto-optical disc, flash memory, or the like, for example. Alternatively, the above-described computer program may be distributed via a network without using the storage medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

What is claimed is:

1. A communication device comprising:
a wireless communication section capable of wirelessly transmitting and receiving a signal to and from another communication device; and
a control section configured to control the wireless communication section in such a manner that the wireless communication section performs a first process and a second process, the first process including transmitting the signal while switching a frequency to be used among a plurality of frequencies, the second process including performing communication by using an optimum frequency that is a frequency selected from among the plurality of frequencies in the first process.

2. The communication device according to claim 1, wherein
the wireless communication section receives information indicating the optimum frequency, and
the control section performs control in such a manner that the communication is performed by using the optimum frequency indicated by the received information.

3. The communication device according to claim 2,
wherein, to receive the information indicating the optimum frequency, the wireless communication section receives a signal transmitted by using the optimum frequency.

4. The communication device according to claim 3, wherein
the wireless communication section receives the signal transmitted by using the optimum frequency while switching the frequency to be used among the plurality of frequencies, and
the control section identifies a frequency of a signal that satisfies a predetermined condition as the optimum frequency among respective signals received by using the plurality of frequencies.

5. The communication device according to claim 4,
wherein the predetermined condition is a condition that the signal has highest reception strength among the plurality of frequencies.

6. The communication device according to claim 4,
wherein the predetermined condition is a condition that a first received signal has highest reception strength among the plurality of frequencies.

7. The communication device according to claim 1,
wherein the second process is a process of measuring a distance between the communication device and the other communication device.

8. A communication device comprising:
a wireless communication section capable of wirelessly transmitting and receiving a signal to and from another communication device; and
a control section configured to control the wireless communication section in such a manner that the wireless communication section performs a first process and a second process, the first process including receiving the signal while switching a frequency to be used among a plurality of frequencies, the second process including performing communication by using an optimum frequency that is a frequency selected from among the plurality of frequencies in the first process.

9. The communication device according to claim 8,
wherein the control section selects a frequency of a signal that satisfies a predetermined condition as the optimum frequency from among signals received in the first process.

10. The communication device according to claim 9,
wherein the predetermined condition is a condition that the signal has highest reception strength among the plurality of frequencies.

11. The communication device according to claim 9,
wherein the predetermined condition is a condition that a first received signal has highest reception strength among the plurality of frequencies.

12. The communication device according to claim 9,
wherein the predetermined condition is a condition that a distance measured between the communication device and the other communication device on the basis of a received signal is shortest among the plurality of frequencies.

13. The communication device according to claim 8,
wherein the wireless communication section transmits information indicating the optimum frequency.

14. The communication device according to claim 13,
wherein, to transmit the information indicating the optimum frequency, the wireless communication section transmits a signal by using the optimum frequency.

15. The communication device according to claim 8,
wherein the second process is a process of measuring a distance between the communication device and the other communication device.

16. A non-transitory computer readable storage medium having a program stored therein, the program causing a computer to control a wireless communication section in such a manner that the wireless communication section performs a first process and a second process, the computer being configured to control a communication device including the wireless communication section capable of wirelessly transmitting and receiving a signal to and from another communication device, the first process including transmitting the signal while switching a frequency to be used among a plurality of frequencies, the second process including performing communication by using an optimum frequency that is a frequency selected from among the plurality of frequencies in the first process.
